(19) United States
(12) Patent Application Publication
(10) Pub. No.: US 2026/0077696 A1
(43) Pub. Date: Mar. 19, 2026

(54) MODULAR DUMP BODY FOR A TRUCK

(71) Applicant: MHJ USA, LLC, Fremont, OH (US)

(72) Inventor: Christopher JAMES, Fremont, OH (US)

(73) Assignee: MHJ USA, LLC, Fremont, OH (US)

(21) Appl. No.: 18/886,087

(22) Filed: Sep. 16, 2024

(51) Int. Cl. B60P 1/28; B62D 65/02

(52) U.S. Cl. CPC B60P 1/28; B62D 65/02

(57) ABSTRACT

A modular dump body system for trucks designed for efficient assembly, disassembly, and transportation is disclosed. The dump body includes separable sections, facilitating compact configuration for reduced shipping volume and costs. This modularity also enables rapid assembly and disassembly on-site, minimizing downtime and labor requirements. By eliminating the need for specialized welding or shipping, the system offers enhanced cost-effectiveness and ease of use during assembly.

### GENERAL DESCRIPTION

This application relates to a truck dump body or tray. Specifically, a modular dump body, tray or loading bed that may be disassembled and reassembled in order to provide efficient packaging when being shipped.

Traditional rigid truck dump bodies present significant logistical and operational challenges, particularly for heavy-duty applications. Sectional dump bodies, while offering some flexibility, necessitate complex and time-consuming assembly procedures. Typically manufactured in separate sections, these bodies are shipped to the customer for on-site welding, a process that may take six to nine days. This method often requires skilled labor, specialized equipment, and a semi-controlled environment, as factors like wind, dust, moisture, and extreme temperatures may hinder welding quality. Furthermore, should the assembled body require relocation, the assembly must be cut apart for transport, adding another layer of complexity and cost.

One-piece dump bodies, while avoiding the intricacies of on-site assembly, present their own set of challenges. Their large size and weight make manufacturing and transportation particularly costly and logistically demanding. Extensive route planning, specialized permits, and skilled personnel are necessary to move these oversized units, often requiring complex and expensive transportation methods by sea or land.

Both sectional and one-piece designs share a significant drawback: the difficulty of downsizing once assembled. Over a truck's lifespan, especially in demanding applications like mining, the dump body may require multiple rebuilds or replacements. This necessitates cumbersome and costly disassembly and reassembly processes, placing a significant burden on the customer and potentially leading to operational downtime. In certain environments or locations, the disassembly process may even prove impractical or impossible due to space constraints or lack of resources.

Thus, there is a clear demand for a truck dump body solution that overcomes the limitations as discussed above. A system is needed that simplifies manufacturing and assembly, eliminating the reliance on specialized personnel and equipment like welders and welding tools. A unique modular dump body is provided herein. The modular dump body minimizes logistical hurdles and streamlining the assembly/disassembly process, and may significantly reduce costs, time, and resources required throughout its operational life.

### SUMMARY

The embodiments disclosed herein relate to a modular dump body that reduce the logistical costs and requirements for transporting a dump body and allow ease of assembly and disassembly.

According to one embodiment, a modular dump body for a truck is disclosed. The modular dump body includes a center section having a left center flange located on a left side and a right center flange located on a right side of the center section. Left flange dowels extending from the left center flange and right flange dowels extending from the right center flange. A first side section having a first side flange, wherein the first side flange is connected to the left center flange via the left flange dowels. A second side section having a second side flange, wherein the second side flange is connected to the right center flange via the right flange dowels. The left and right flange dowels are configured to prevent separation of the first side section and the second side section from the center section in a left and right direction respectively.

According to another embodiment, a modular dump body for a truck is disclosed. The modular dump body includes a left side section and a right side section, both adjacent to a center section. The modular dump body is selectively configurable between a first state and a second state. In the first state, the left section is connected to a left side of the center section and the right section is connected to a right side of the center section. In the second state, the left section is temporarily fastened with the right section and is placed above the center section. The second state has a smaller footprint than the first state.

According to another embodiment, a method of configuring a dump body is disclosed. The method includes the steps of assembling the dump body by unfastening and separating a connected left section and right section placed above a center section. Hoisting the left section and right section via lifting points located on the left section and right section. Lowering notches of the left section towards a left side of the center section onto left dowels of center section. Fastening the left section onto the center section through fastening holes of flanges of the left section and center section. Lowering notches of the right section towards a right side of the center onto right dowels of the center section. Fastening the right section onto the center section through fastening holes of flanges of the left section and center section.

### BRIEF DESCRIPTION OF THE DRAWINGS

FIG. 1 shows an isometric view of the modular dump body

FIG. 2 shows an isolated center section of the modular dump body shown in FIG. 1

FIG. 3 shows an isolated center section of the modular dump body shown in FIG. 1

FIG. 4 shows a close up of the isolated center section of the modular dump body shown in FIG. 2

FIG. 5 shows an isolated right section of the modular dump body shown in FIG. 1.

FIG. 6 shows an isolated right section of the modular dump body shown in FIG. 1.

FIG. 7 close up of the notches of the side section.

FIG. 8 shows an isolated left section of the modular dump body shown in FIG. 1.

FIG. 9 shows a side view of the side section.

FIG. 10 shows a side section of the center section.

FIG. 11 shows a shipping configuration of the modular dump body.

### DETAILED DESCRIPTION

The particulars shown herein are by way of example and for purposes of illustrative discussion of the disclosed embodiments and are presented to provide a readily understood description of the principles and conceptual aspects. In this regard, no attempt is made to show structural details in more detail than is necessary for a fundamental understanding, and the description taken together with the drawings make apparent to those skilled in the art how the disclosed devices and methods may be embodied in practice.

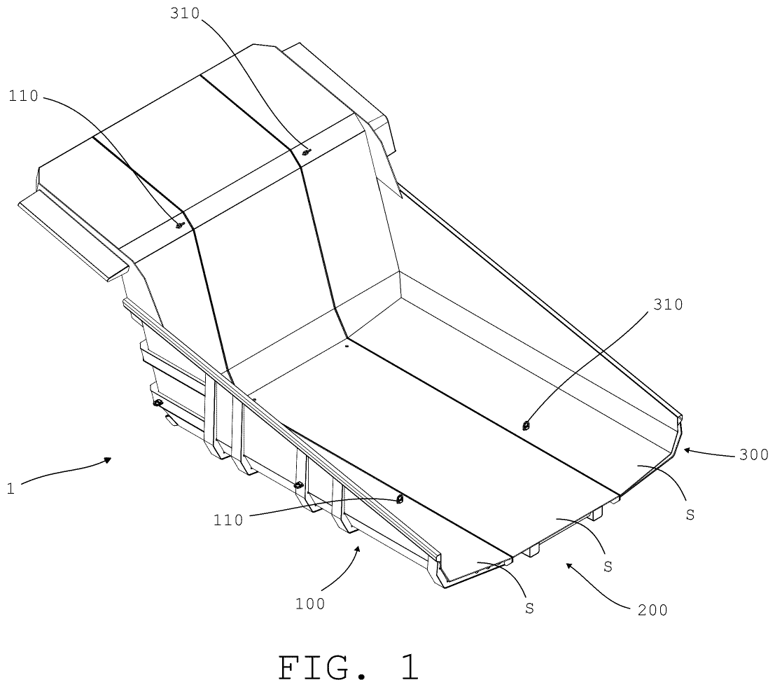

FIG. 1 shows an exemplary modular dump body 1 for a truck. The dump body 1 includes a center section 200 and two side sections 100 (left side section) and 300 (right side section). The dump body may also be referred to as a tray or loading bed.

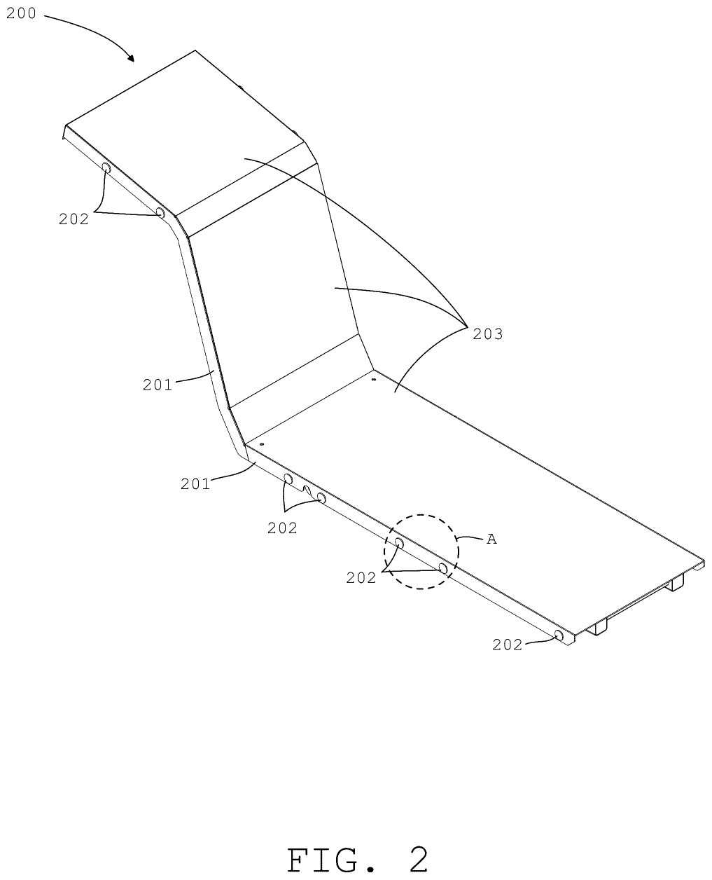

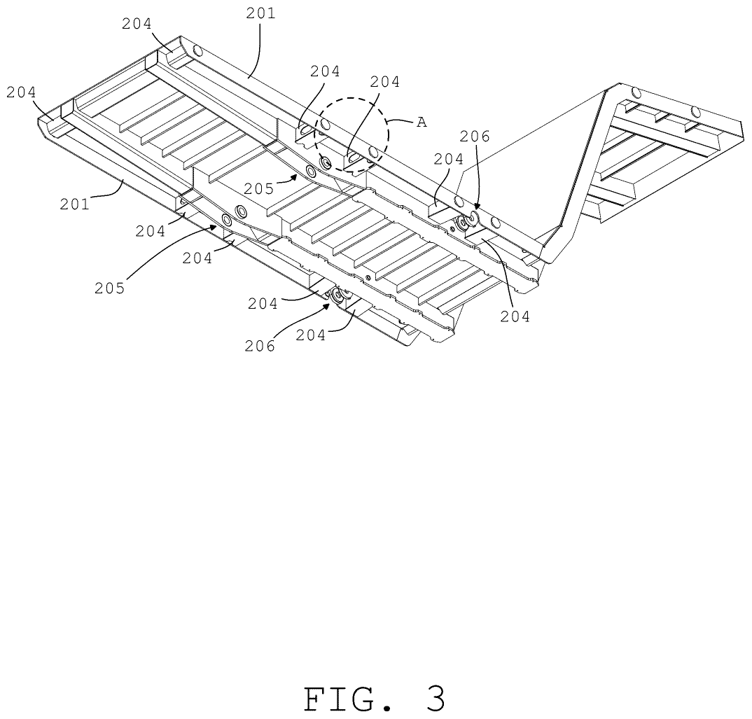

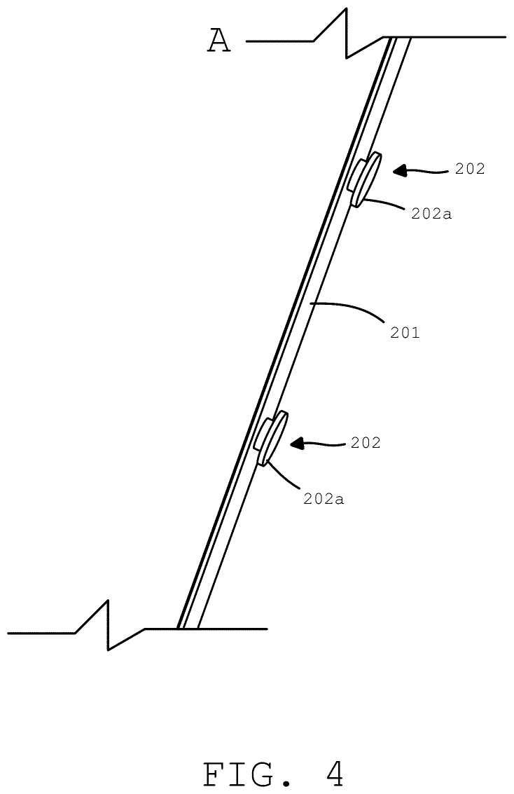

FIGS. 2 and 3 shows the center section 200 from a top and bottom perspective, respectively. The center section 200 includes a flange 201 along its entire length on its side. The flanges are fitted on both sides where the center section 200 meets with the left section 100 and the right section 300. The flanges are braced onto the main body 203 of the center section 200 via perpendicular cross bracing 204. The flange is also welded along its entire length for strength. Positioned along the flanges 201 are dowels 202. These dowels are configured to assist in assembly of the modular dump truck body 1. The dowels 202 protrude from the flange and includes an end plate 202a (see FIG. 4) to prevent the side sections 100 and 300 from sliding once assembled. The dowels may also act as an alignment structure until fasteners are installed to combined the side sections 100/300 to the center section 200. The underside of center section 200 may further incorporate pivot attachments 205 and actuator attachments 206. Actuator attachments 206 are designed to interface with a truck dump body actuator (not shown). A conventional actuator may be used in conjunction with pivot attachments 205 secured to corresponding hard points on the truck frame, to thereby enable controlled rotation of the assembled dump body 1 about the pivot attachments 205.

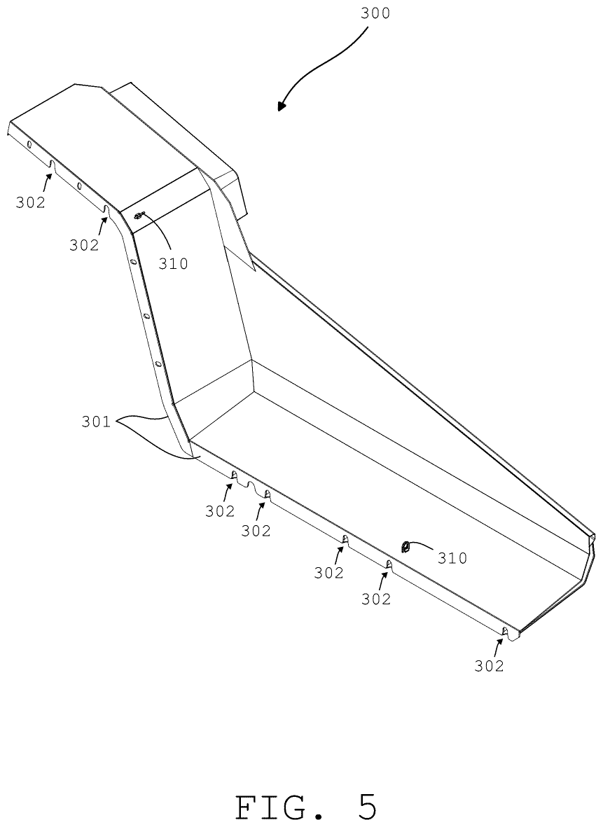

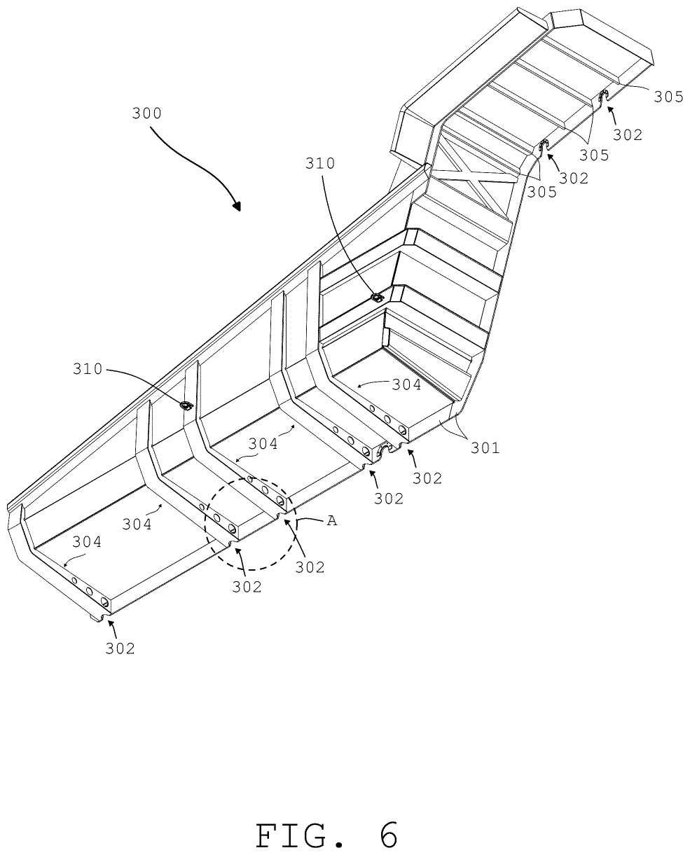

FIGS. 5 and 6 shows the right section 300 from a top and bottom perspective, respectively. The right section 300 includes flange 301 and receiving notches 302 at predetermined locations corresponding to locations of dowels 202 from the center section. The receiving notch 302 is configured to accommodate the dowel 202 from the center section 200. Bottom notches 302a are braced with a reinforcement plate 303 and right section crossbeams 304. The crossbeams 304 strengthens the section and ensures the integrity of the flange 301. The crossbeams 304 also box these bottom notches 302a to provide even further rigidity to the structure in the area around the notches 302a. The upper notches 302b are located on the forward most of the section. In this area, cross beams 305 are also provided to strengthen the structure.

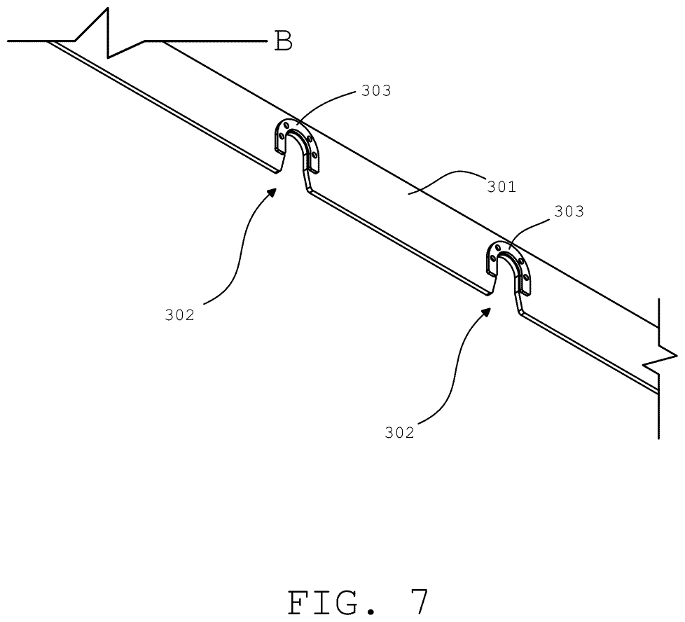

A close up of the notches 302 is shown in FIG. 7. The crossbeams 304 have been omitted for clarity in this figure. Reinforcement plates 303 are shaped to correspond with the shape of the notch. Reinforcement plates care configured to reinforce the structural integrity of the notch 302. The omitted crossbeams 304 are hollow and surround both the reinforcement plates 303 and the notch 302. The left section includes identical components on flange 101, containing reinforcement plate 103 on notches 102.

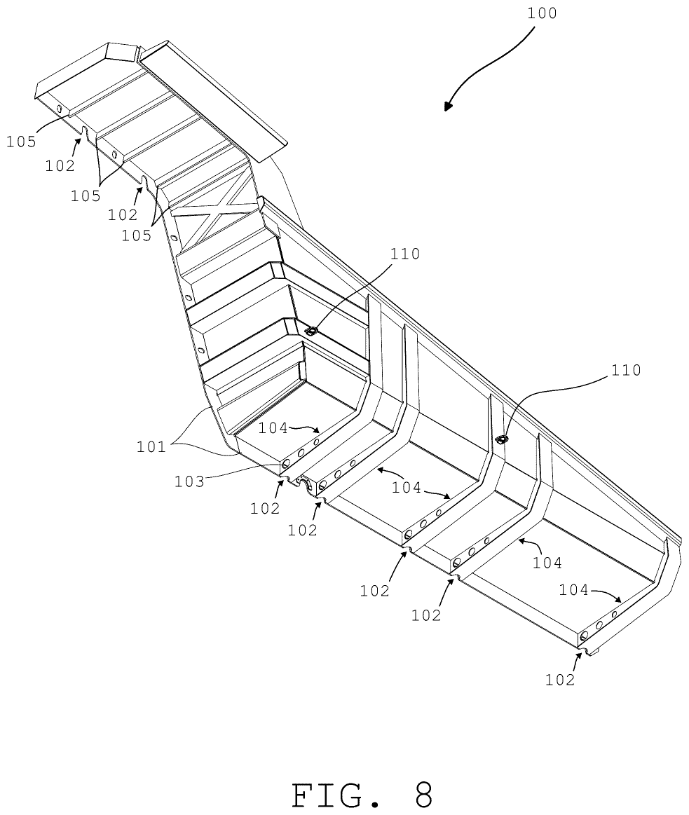

The left section 100, shown in FIG. 8 is a mirror image to the right section 300 shown in FIG. 6 with identical corresponding components. The left section 100, similarly to right section 300, INCLUDES a flange 101, notch 102, reinforcement plate 103, cross beams 104, and upper cross beams 105.

Other cross beams not labeled but shown in FIGS. 3, 6 and 8 may be utilized to strengthen the structure of the dump body.

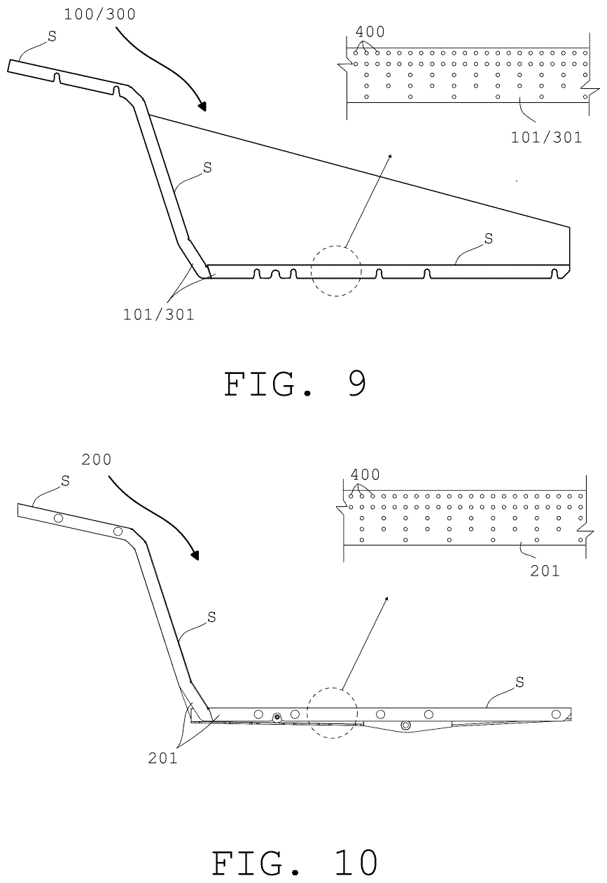

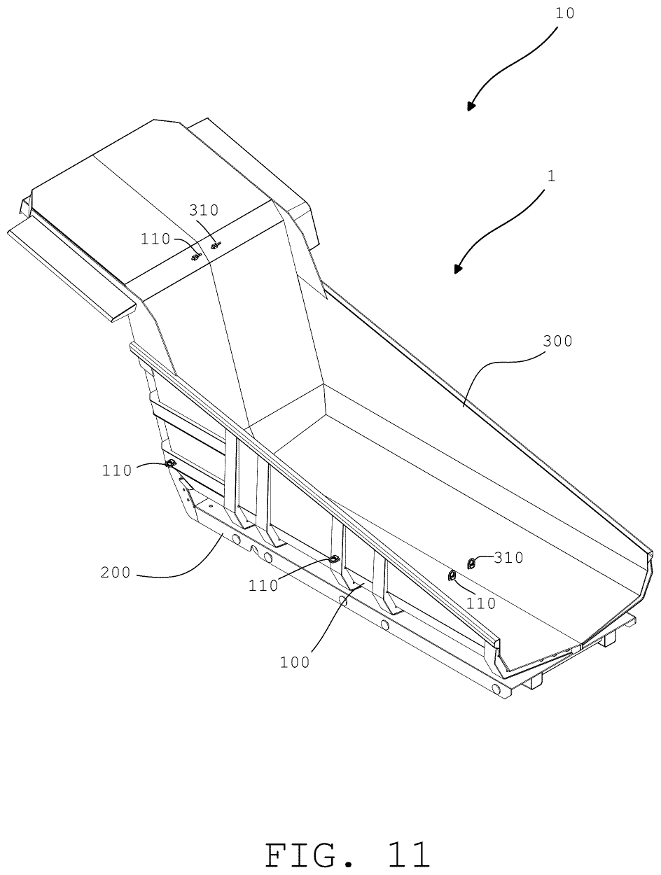

FIGS. 9 and 10 provide a detailed view of the flanges on the center section 200 and side sections 100/300. All flanges are pre-drilled to accommodate fasteners, preferably Huck fasteners, for secure assembly. The drilling pattern of fastening holes 400 on the flanges is strategically distributed based on proximity to the section loading surface ‘S.’ Denser drilling patterns are employed closer to surface ‘S,’ while the pattern becomes progressively wider farther away from the surface ‘S’. This distribution serves to mitigate debris and material ingress into the flange mating area. Without proper fastening and a strategically designed drilling pattern, the accumulation of debris in this area could compromise the integrity of the flange connection over time. The tighter fastener spacing near surface ‘S’ effectively prevents such ingress, enhancing the longevity and reliability of the assembly.

The sections are joined by utilizing huck fasteners through fastening holes 400. Each huck fastener includes a huck bolt and a huck collar. The huck collar is swaged onto the huck bolt via a huck fastening tool (e.g., a huck gun). The collar is smooth (i.e., unthreaded) on the inside and, unlike a nut. The huck fastening tool pulls the bolt's pintail at the end of the bolt threads in order pull the gun onto the collar, where the collar is drawn into the recess in the nose of the huck fastening tool, causing the collar to be pressed firmly into the threads of the bolt and swage tightly around the bolt threads to create a semi-permanent connection (e.g., the collars need to be cut to be unfastened). The threads of the huck bolt have a unique geometry compared to a standard bolt. Unlike conventional bolts, huck bolts feature threaded grooves that mechanically lock the collar in place. This secure, permanent installation, as opposed to traditional nut-and-bolt assemblies, provides huck bolts with significantly higher fatigue strength and resistance to vibrational loosening. The use of huck fasteners reduce the assembly and disassembly process by a significant amount compared to traditional welding.

FIG. 11 shows a shipping configuration 10. The shipping configuration allows the modular dump body to be shipped on a 40′ flat rack. This mode of shipping reduces costs by 80% on a 100 ton class truck body. The left 100 and right 300 sections are joined together via shipping bolts and the center section is placed below the joined left and right sections. The modular dump body is manufactured into the sections. After manufacturing, the tray is formed into a “kit”. The left section 100 and right section 300 are bolted together using transport bolts. These transport bolts are only used while in transit and not used for working application. With the left 100 and right 300 sections bolted together, the shipping footprint is may be reduced up to 42%, by forming a narrower shipping package. The modular dump body also allows up to approximately 80 to 90% reduction in assembly time and 60 to 70% reduction in disassembly time. The modular dump body may be made into different sizes. In this shipping configuration, the modular dump body may be transported without the need for oversized support equipment and documentation as required in many countries.

Referring back to FIGS. 1, 5, 6, and 8, the left 100 and right 300 sections of the dump body 1 may include lifting points 110/310 welded around the center of gravity of each section. The lifting points are fixed on the loading surface ‘S’ of the sections. Additional lifting points are located on the sides of the respective sections. These lifting points are used for moving the modular lift body for assembly/disassembly and mounting to the truck. These lifting points 110/310 may also be utilized for fastening the dump body 1 together in the shipping configuration as seen in FIG. 11.

To reconfigure the modular dump body 1 from its compact shipping configuration (i.e., shipping state or second state) 10 to its operational state (i.e., first state), as seen in FIG. 1, the transport bolts securing the left 100 and right 300 sections are removed. Once removed, one side (e.g., either of the left section 100 or right section 300) is lifted and lowered onto the center section by lining the notches 102/302 to the corresponding dowels 202 on the center section 200. The lowered side section remains suspended until all huck fasteners have been installed onto the flange 101 (or 301). The process is then repeated for the other side of the dump body section.

It is noted that the foregoing examples have been provided merely for the purpose of explanation and are in no way to be construed as limiting of implementations of the present invention. While aspects of the present invention have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although implementations of the present invention have been described herein with reference to particular means, materials and embodiments, implementations disclosed herein are not intended to be limited to the particulars disclosed herein; rather, implementations of the present invention extend to all functionally equivalent structures, methods and uses, such as are within the scope of the appended claims.

What is claimed is:

1. A modular dump body for a truck, the modular dump body comprising:
a center section having a left center flange located on a left side and a right center flange located on a right side of the center section;
left flange dowels extending from the left center flange and right flange dowels extending from the right center flange;
a first side section having a first side flange, wherein the first side flange is connected to the left center flange via the left flange dowels;
a second side section having a second side flange, wherein the second side flange is connected to the right center flange via the right flange dowels;
wherein the left and right flange dowels are configured to prevent separation of the first side section and the second side section from the center section in a left and right direction respectively.

2. The dump body of claim 1, wherein the left and right flange dowels are flared and are configured to engage the left and right center flange respectively, thereby preventing separation of the first side section and the second side section in the left and the right direction respectively.

3. The dump body of claim 2, wherein the first side flange and second side flange includes notches located along the length of the first side flange and second side flange, wherein the position of the notches correspond to the position of the left and right flange dowels along the length of the center section.

4. The dump body of claim 3, wherein each notch includes reinforcement plates configured to strengthen the notch.

5. The dump body of claim 1, wherein the left center flange, right center flange, first side flange, and second side flange includes fastening points that are distributed at locations based on a distance from an upper loading surface of the dump body.

6. The dump body of claim 5, wherein the distribution of fastening points becomes progressively wider farther away from the upper loading surface.

7. The dump body of claim 1, wherein the center section includes pivot attachments configured to be attached to the truck and actuator attachments configured to be attached to an actuator configured to rotate the dump body about the pivot attachment.

8. A modular dump body for a truck, the modular dump body comprising:
a left side section and a right side section, both adjacent to a center section;
wherein the modular dump body is selectively configurable between a first state and a second state;
wherein the first state the left section is connected to a left side of the center section and the right section is connected to a right side of the center section;
wherein in the second state the left section is temporarily fastened with the right section and is placed above the center section;
wherein the second state has a smaller footprint than the second state.

9. The dump body of claim 8, wherein the left side section and right side section includes lifting points, wherein the lifting points are utilized to hoist the left side section and right side section onto the center section to achieve the second state.

10. The dump body of claim 9, wherein each of the left side section and right side section include notches that correspond to dowels located on the center section, wherein the left side section and right side section notches are configured to be lowered on to the dowels of the center section to configure the dump body in the first state.

11. The dump body of claim 10, wherein the dowels include a flared end.

12. The dump body of claim 8, wherein each of the center section, left section, and right section includes fastening points that are distributed along the sections at locations that are based on the distance from an upper loading surface of the dump body.

13. The dump body of claim 11, wherein the separation of the fastening points becomes progressively wider farther away from the upper loading surface.

14. The dump body of claim 8, wherein when in the first state, each of the left section and the right section are fastened with huck fasteners to the center section.

15. A method of configuring a dump body, comprising the steps of:
assembling the dump body by unfastening and separating a connected left section and right section placed above a center section;
hoisting the left section and right section via lifting points located on the left section and right section;
lowering notches of the left section towards a left side of the center section onto left dowels of center section;
fastening the left section onto the center section through fastening holes of flanges of the left section and center section;
lowering notches of the right section towards a right side of the center onto right dowels of the center section; and
fastening the right section onto the center section through fastening holes of flanges of the left section and center section.

16. The method of claim 15, wherein the fastening of the left section and right section are performed while the left and right section are still suspended via hoisting.

17. The method of claim 15, wherein the distribution of fastening holes of the flanges of the left section and fastening holes of the flanges of the right section are distributed along the flanges at locations that are based on the distance from an upper loading surface of the dump body.

18. The method of claim 15, wherein the fastening of the left section and right is secured using huck fasteners.

19. The method of claim 15, wherein the method further comprising the step of disassembling the dump body by unfastening the left section and right section from the center section and fastening the left section and right section together.

20. The method of claim 15, wherein the dump body is attached to a truck via a pivot attachment on the center section and to an actuator via an actuator attachment on the center section.
